(19) United States
(12) Patent Application Publication
(10) Pub. No.: US 2026/0103157 A1
(43) Pub. Date: Apr. 16, 2026

(54) Electric connection between an electric device and an electrically operatable vehicle, electric device, and electric vehicle

(71) Applicant: Dynamic Drives Giessen GmbH, Gießen (DE)

(72) Inventors: Andreas Papenfuss, Weimar (DE); Anton Papenfuss, Berlin (DE)

(21) Appl. No.: 19/116,314

(22) PCT Filed: Oct. 6, 2023
(86) PCT No.: PCT/EP2023/077677

§ 371 Date: Apr. 1, 2025

(30) Foreign Application Priority Data
Oct. 14, 2022 (DE) 10 2022 126 977.9

(51) Int. Cl. B60R 16/03; B60K 1/00; B60L 50/20; B60L 50/60

(52) U.S. Cl. CPC B60R 16/0307; B60K 1/00; B60L 50/20; B60L 50/60; B60L 2200/12; B60L 2220/46; B60L 2250/26

(57) ABSTRACT

The invention relates to an electric connection between an electric device (10) and at least one part (20) of an at least partially electrically operatable vehicle, in particular a vehicle with a serial hybrid drive. The electric device (10) has a rotational axle (16) and can be secured to the part (20) of the vehicle in an installed position (10.1). Electric energy and/or data can be transmitted from the vehicle to the electric device (10) and/or from the electric device (10) to the vehicle via the electric connection. Furthermore, at least one plug connector (11) is provided on the electric device (10), and at least one mating plug connector (21) is provided on the vehicle or on the part (20) of the vehicle in order to produce the electric connection, wherein the electric connection between the at least one plug connector (11) and the at least one mating plug connector (21) is established solely by bringing the electric device (10) into its installed position (10.1) on the vehicle. The invention proposes that the plug connector (11) is arranged directly on the rotational axle (16) of the device (10), and the mating plug connector (21) is likewise arranged on the vehicle in the region of the rotational axle (16) of the device (10). A transition piece (14) is provided on which the plug connector (11) is arranged and which bridges a distance between the device (10) and the mating plug connector (21) when the mating plug connector (21) is arranged on the vehicle at a distance from the rotational axle (16) of the device (10). The invention additionally relates to an electric device and to an electrically operatable vehicle.

The invention relates to an electrical connection between an electrical device and an electrically operable vehicle, and to an electrical device and an electrically operable vehicle. Fully or partially electrically operated vehicles have become more popular in recent years. Even wheelbarrows, E-bicycles or PEDs are becoming increasingly popular. Frequently, such vehicles are driven directly by a person via pedals and supported by one or more electric motors which can be switched on if necessary. The energy for the electric motors is provided by a battery which has to be charged or exchanged again repeatedly.

Furthermore, it is also possible to equip the vehicle with a serial hybrid drive. In this case, the drive of the vehicle is realized only by the energy stored in the battery and one or more electric motors. Connected to the pedals is a generator which converts the energy generated during actuation of the pedals and stores it into the battery. This makes it possible to dispense with a drive chain, the vehicle becomes easier because the mechanical drive train can be dispensed with and it requires less maintenance. This is also important in particular in the region of the load wheels.

However, it is problematic in such electrically operated vehicles if one of the electrical devices—the motor or the generator—is defective and must be replaced. In this case, not only the electrical device has to be removed mechanically, replaced and re-installed, but also the associated electrical connections must be reliably released and reconnected. However, it is not easy for a layperson to carry this out, however, if the defect occurs, for example, while a journey is underway such that it must be remedied immediately. Frequently, damage or tearing of the connecting cable occurs at the electrical device or there is a faulty connection.

A motor for an electric bicycle is described in EP 4 151 513 A1. The motor is arranged in the fork of the bicycle. When the motor is mounted on the fork of the bicycle, a plug connector is connected to the motor with a mating connector on the fork in order to establish an electrical connection. This motor with plug-in connectors can be used only in the case of forks in which the mating plug connector has a certain distance from the motor and which is displaced perpendicular to the axis of the motor. If the mating plug connector is seated on the axis of the motor or is arranged parallel thereto, a completely differently designed motor is necessary, since otherwise the electrical connection to the mating plug connector does not work.

DE 20 2013 1102 672 U1 describes a cable connection for a motor on an electrically operable bicycle. The plug connector is arranged directly on the axis of rotation of the motor and, during assembly of the motor, a connecting piece, which comprises the mating plug connector, is plugged concentrically to the axis of rotation of the motor onto the plug connector. However, if the mating plug connector is provided on the bicycle at a different location and is arranged, for example, at a distance from the axis of rotation of the motor, this type of motor cannot be mounted in this bicycle, but a new variant of the motor is necessary.

EP 3 733 495 A1 describes an electrically powered two-wheeler. It provides an electrical component located in an electrical path between the electric motor and a battery. This can, for example, be a terminal block that connects one end of the electrical cable leading from the electric motor to an electrical cable leading from the battery. These cable ends must be professionally connected to each other via the terminal block, for example, using a clip or screw connection. The electrical connection is not automatically established during mechanical assembly of the motor and cable; rather, the electrical connection must be established separately. The same applies if the motor is disassembled. A careless layperson could damage the cable if they do not disconnect the electrical connection before removing the motor.

FR 3 065 704 describes a frame for a bicycle with electrical assistance. A battery is provided in one frame section and a motor in another frame section. A cable is used to establish the electrical connection between these elements. Furthermore, replacing the motor is complicated because it is located in a part of the frame and cannot be easily removed by a layperson in the event of a breakdown.

Document DE 10 2021 132 524 A1 describes a human-powered vehicle, such as a bicycle. An electric drive with an electric motor is provided at the hub of the vehicle. A cable extends from the hub, at the end of which is a connector that can be connected to a battery or similar device to supply the electric motor with electrical power. Here, too, an operator must disconnect this connector and then disassemble the hub in order to remove the electric motor in the event of a breakdown. Here, there is again a risk that a layperson will forget to disconnect the electrical connection before disassembling the hub or to restore the electrical connection after replacing the electric motor. Furthermore, replacing the electric motor is complicated because the entire hub has to be removed.

It is therefore an object of the invention to avoid the aforementioned disadvantages and to develop an electrical connection as well as an associated electrical device and a corresponding vehicle, in which replacement of the electrical device can also take place in a rapid and simple manner by a a layperson and in which the assembly can take place independently of whether the mating plug connector is arranged at a distance from the device in the region of the axis of rotation of the device. These objects are achieved by the characterizing features of claims 1, 12 and 13 which have the following particular significance.

The electrical device has a mounting position in which it can be fastened to a vehicle or to a part of a vehicle. Furthermore, the device has at least one plug connector, wherein the vehicle has at least one mating plug connector. If the electrical device is now moved into its mounting position, the plug connector and the mating plug connector are automatically brought into operative connection with one another and the electrical connection is produced. An extra connection for the electrical parts is thus not necessary. As a result, both damage to the electrical lines and incorrect connection, such as, for example, polarity reversal, are avoided. The change of the electrical unit can also take place more quickly, since it is not necessary to separate and rejoin the electrical connection again and again. The exchange of the electrical device can also be carried out simply by a layman with few tools required. Furthermore, a transition piece is provided which bridges the distance between the device and the mating plug connector when such is required. This is important in particular if the mating plug connector is not provided directly on the receptacle due to structural conditions of the vehicle or of the part of the vehicle. The transition piece is then mounted on the device or on its housing and, during assembly of the device, automatically establishes the electrical connection between the plug connector and the mating plug connector. The transition piece can therefore preferably have a guide which has a certain strength, so that additional mounting, e.g. manual plugging, of the plug connector and of the mating plug connector is not required.

It is particularly advantageous if the mounting position of the electrical device on the vehicle is mechanically clearly defined. As a result, the electrical device can only be arranged in the correct position on the vehicle, an incorrect arrangement is not possible. Thus, the device is protected against assembly errors, since an incorrect connection is not possible.

The electrical device can be, for example, a motor and/or a generator. A transmission also comes into consideration here. The motor can be used to drive one or more wheels of the vehicle. The generator can be used, for example, to convert energy generated by an operator during actuation of the pedals into electrical energy and to feed it into the battery and/or to directly drive a motor.

The device can be arranged in the region of the wheel hub of a wheel of the vehicle. This is expedient in particular in the case of motors which drive the corresponding wheel. Alternatively, the device can also be arranged in the region of the pedals of the vehicle. If the device is a generator, the actuation of the pedals can be converted directly into electrical energy by the operator. In this case, the pedals can be designed to be operable by the operator by the foot or else manually.

Advantageously, at least one receptacle for the device or at least part of the device is provided on the vehicle or on a part of the vehicle. When transferred into the assembly position, the device is then introduced completely or in regions into the receptacle. This makes the correct placement and positioning of the device for an operator simpler and less error-prone.

In a particular embodiment, an adapter is provided which can be fastened to the vehicle or to a part of the vehicle and which has the receptacle for the electrical device. The adapter can be fastened to the vehicle in a detachable manner or else non-detachably, for example by welding or adhesive bonding. In this case, the adapter can be designed in the manner of a capsule and have a body and a cover which is detachably fastened to the body. The receptacle for the electrical device is then located in the interior of the capsule. Such an adapter is advantageous in particular for accommodating a generator because it can be arranged well between the pedals and withstands the mechanical loads.

In a preferred exemplary embodiment, the mating plug connector required for the production of the electrical connection can be arranged on the receptacle or also on the adapter. Plug-in connectors and mating plug-in connectors are then automatically operatively connected to one another when the device is inserted and the receptacle is inserted. Here too, the transition piece can be used when the mating plug connector is spaced apart from the adapter.

In a preferred embodiment, the device has a housing on which the plug connector is arranged. In this case, the plug connector is provided on the outside of the housing. The device is well protected and easy to handle by the housing against damage, weather influences and contamination. Due to the arrangement on the outside of the housing, the plug connector is also securely arranged at a well accessible location.

Furthermore, the invention also comprises an electrical device for use on or in an at least partially electrically operable vehicle and suitable for the production of the electrical connection. In this case, the electrical device has at least one plug connector which is accessible from the outside and which then comes into operative connection automatically with a mating plug connector during assembly on or in the vehicle and establishes the electrical connection. Furthermore, the device also comprises a motor and/or a generator and/or a transmission.

Finally, a vehicle is also encompassed by the invention which comprises at least one electrical device according to the invention and at least one electrical connection according to the invention. Of course, the vehicle can also have a plurality of identical or different electrical devices according to the invention and also a plurality of or a plurality of electrical connections according to the invention.

Further advantages and exemplary embodiments result from the following description, the dependent claims and the drawings. In the drawings, the invention is illustrated in three embodiments.

### BRIEF DESCRIPTION OF THE DRAWINGS

FIG. 1: a first exemplary embodiment of a device according to the invention in a perspective side view,

FIG. 2: shows the device from FIG. 1 in the mounting position,

FIG. 3: shows a receptacle for a device according to FIGS. 1 and 2,

FIG. 4: shows the receptacle from FIG. 3 in exploded view,

FIG. 5: shows the device from FIG. 1 and a transition piece, in perspective,

FIG. 6: the transition piece from FIG. 5, in perspective,

FIG. 7: a guide, in perspective,

FIG. 8: the transition piece from FIG. 6 and the guide from FIG. 7 in the assembled state, in perspective,

FIG. 9 shows a device according to the invention in a second exemplary embodiment with an adapter, in perspective in exploded view,

FIG. 10: shows the device from FIG. 9 in perspective from the other direction,

FIG. 11: a device according to the invention in a third embodiment in a perspective exploded view prior to assembly,

FIG. 12: shows the device from FIG. 11 in perspective from the other direction,

FIG. 13: shows the device from FIGS. 11 and 12 at the beginning of assembly, in perspective,

FIG. 14: shows the device from FIG. 13 in perspective from the other direction,

FIG. 15: shows the device from FIGS. 11 to 14 shortly before completion of assembly, in perspective,

FIG. 16: shows the device from FIG. 15 in perspective from the other direction,

FIG. 17: shows the device from FIGS. 11 to 16 in the mounting position, in perspective,

FIG. 18: shows the device from FIG. 17 in perspective from the other direction.

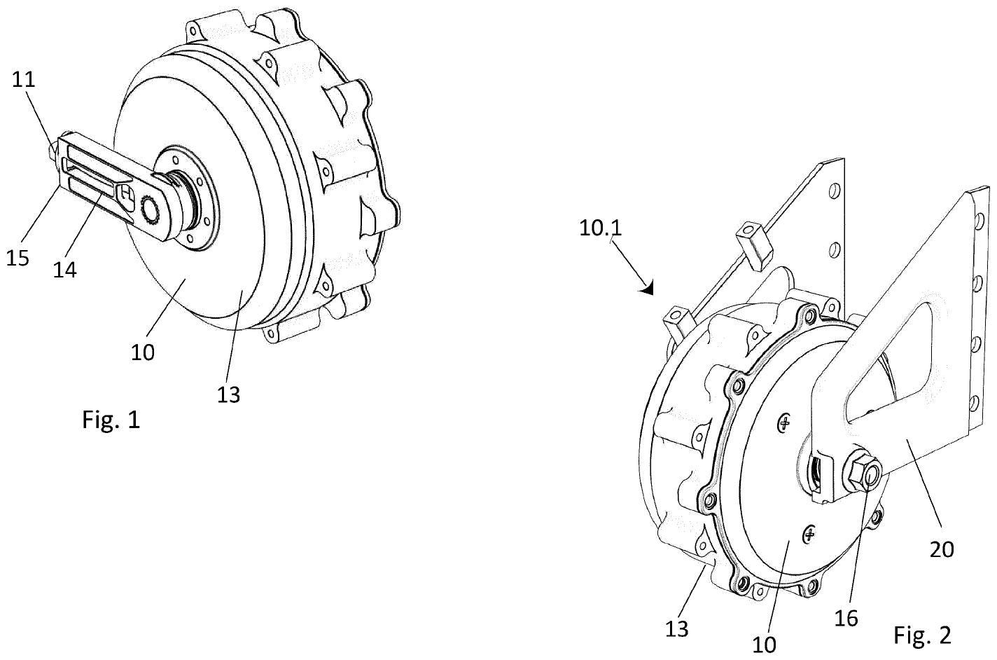

FIG. 1 shows an electrical device 10 with a housing 13. A transition piece 14 is arranged on the outside of the device 10, at one end of which the plug connector 11 is provided. This device 10 is provided in particular for two-sided mounting on a part 20 of a vehicle, for example on a fork of an E-bike or the like. In this case, the transition piece 14 bridges the distance between the device 10 itself and the mating plug connector 21. The device 10 itself also has a plug connector 11, wherein the transition piece 14 has a mating plug connector 21 which interacts with the plug connector 11 on the device 10. The mounting position 10.1 of the electrical device 10 can be seen from FIG. 2. The device is arranged on the part 20 of the vehicle, namely on the fork. The plug-in connector 11 has been brought into connection with the mating plug connector 21 by bringing about the mounting position 10.1 and the electrical device 10 itself is securely fixed to the part 20 of the vehicle. The receptacle 12 for the device 10 is located here between the two halves of the part 20 of the vehicle, as will be shown. Furthermore, the axis of rotation 16 of the device 10 can be seen here. The plug connector 11 on the device 10 is arranged here on the remote, non-visible end of the axis of rotation 16.

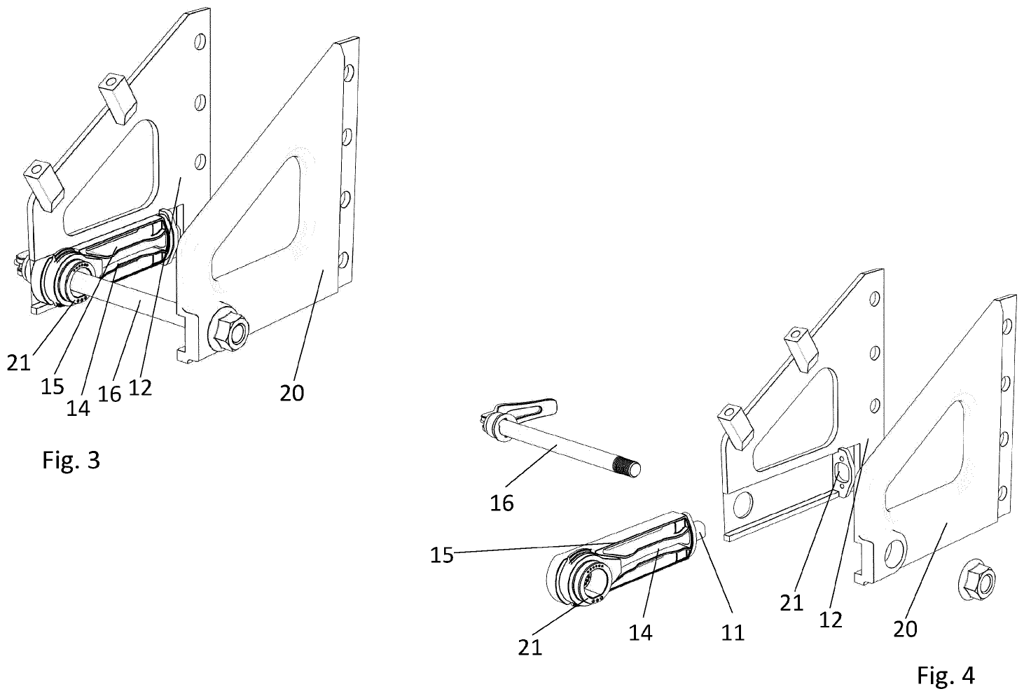

A more precise construction of this embodiment with transition piece 14 is shown in FIGS. 3 and 4. The electrical device 10 has been omitted here for the sake of clarity. FIG. 3 shows how the mating plug connector 21 is provided on the transition piece 14 for cooperating with the plug connector 11 on the electrical device 10. The transition piece 14 is arranged in a guide 15 and has at its other end a plug connector 11 which can be brought into operative connection with the mating plug connector 21 on the vehicle in order to establish the electrical connection. The exploded view from FIG. 4 shows the plug connector 11 and the mating plug connector 21 in the unmounted state. It can also be seen that the transition piece 14 bridges the distance between the axis of rotation 16 of the electrical device 10 and the mating plug connector 21 on the vehicle. The receptacle 12 for the device 10 is arranged centrally between the two elements of the part 20 of the vehicle.

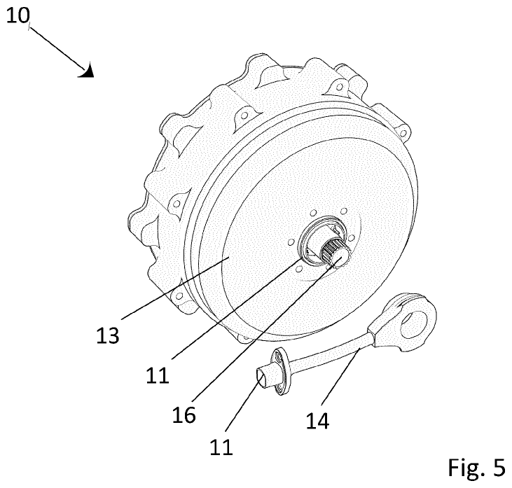

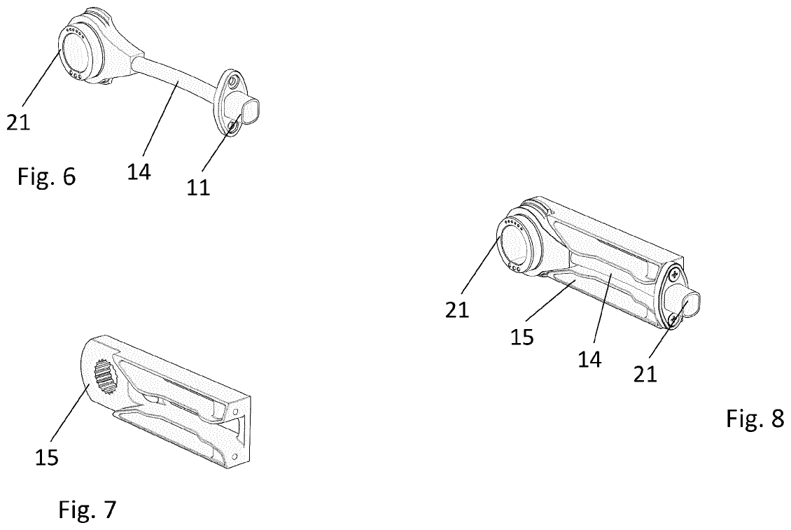

FIG. 5 shows an electrical device 10 according to the invention with housing 13 and a transition piece 14. The transition piece 14 can be arranged on the axis of rotation 16 of the electrical device 10 and thus on the plug connector 11. The transition piece 14 is shown again in the following FIG. FIG. 6 shows the transition piece 14 with the mating plug connector 21 for the plug connector 11 on the electrical device 10 and with the plug connector 11 for electrical contacting with the mating plug connector 21 on the vehicle. FIG. 7 shows a guide 15 into which the transition piece 14 can be introduced. This then results in the situation shown in FIG. 8. The guide 15 ensures that the plug-in connector 11 on the transition piece 14 comes into electrical contact with the mating plug connector 21 on the vehicle.

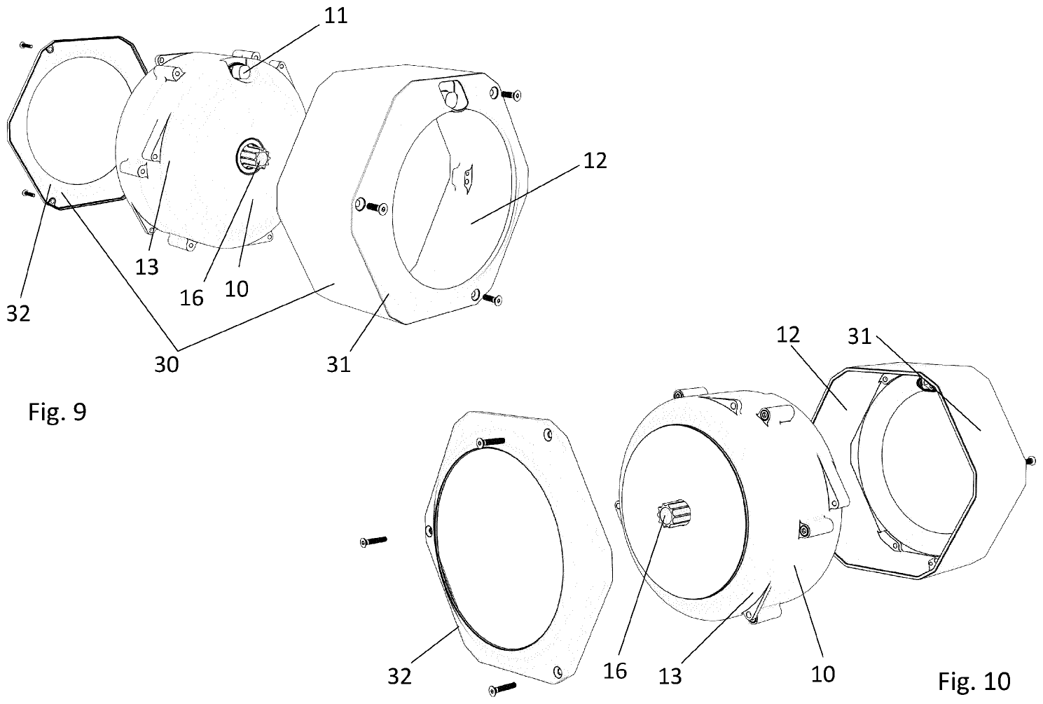

A further exemplary embodiment is shown in FIGS. 9 and 10. Here, an adapter 30 is provided which simultaneously forms the receptacle 12 for the electrical device 10. The adapter 30 comprises a body 31 and a cover 32 which is detachably fastened to the body 31. The cover 32 is fastened to the body here by means of screws. However, other fastening possibilities are also conceivable, such as clip connections or latching connections, bayonet closures, etc. The electrical device 10 can thus be accommodated within the adapter 30. This embodiment is particularly preferably to be used in electrical devices 10 which are located in the pedals to be actuated by the operator.

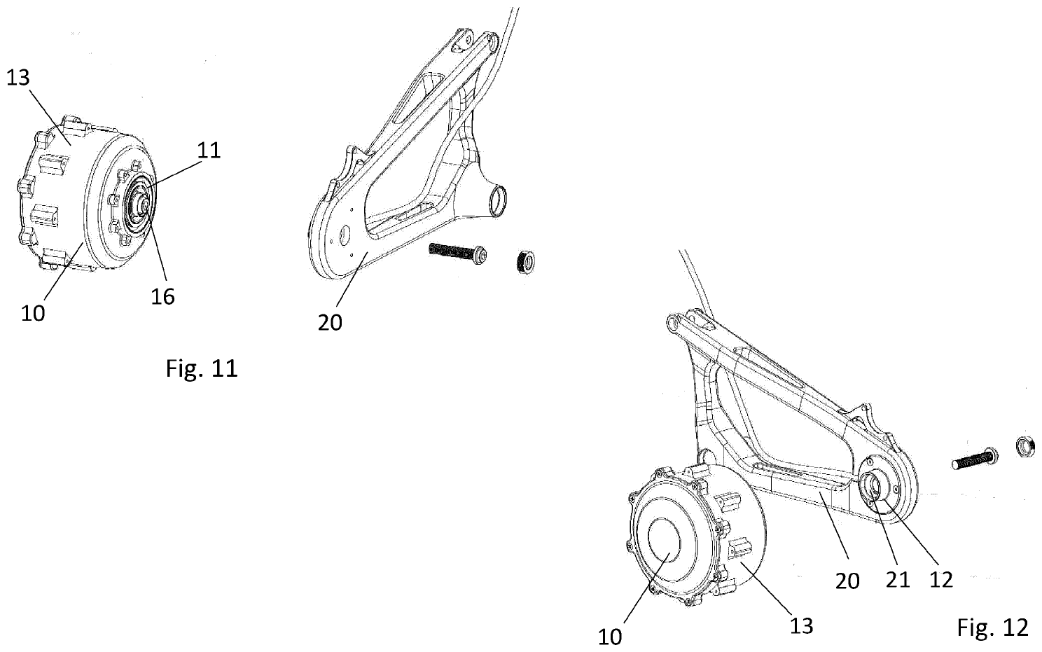

A third embodiment of the invention is shown in FIGS. 11 to 16. Here, the electrical device 10 is attached only on one side to a part 20 of a vehicle. A rocker or a dropout can serve as part 20 of a vehicle, for example. The very simple assembly of the device 10 is also clear from FIGS. 11 to 16.

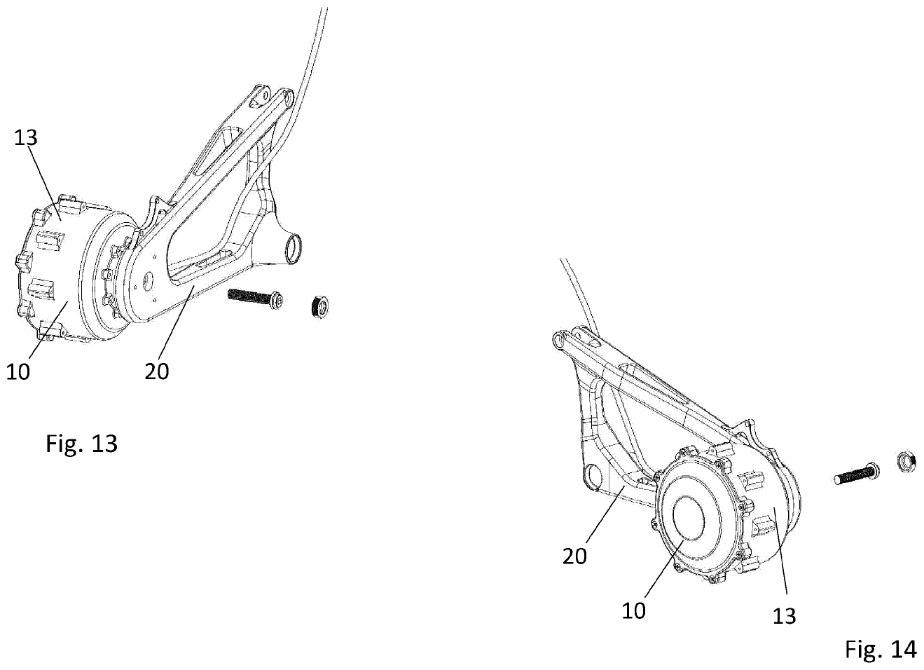

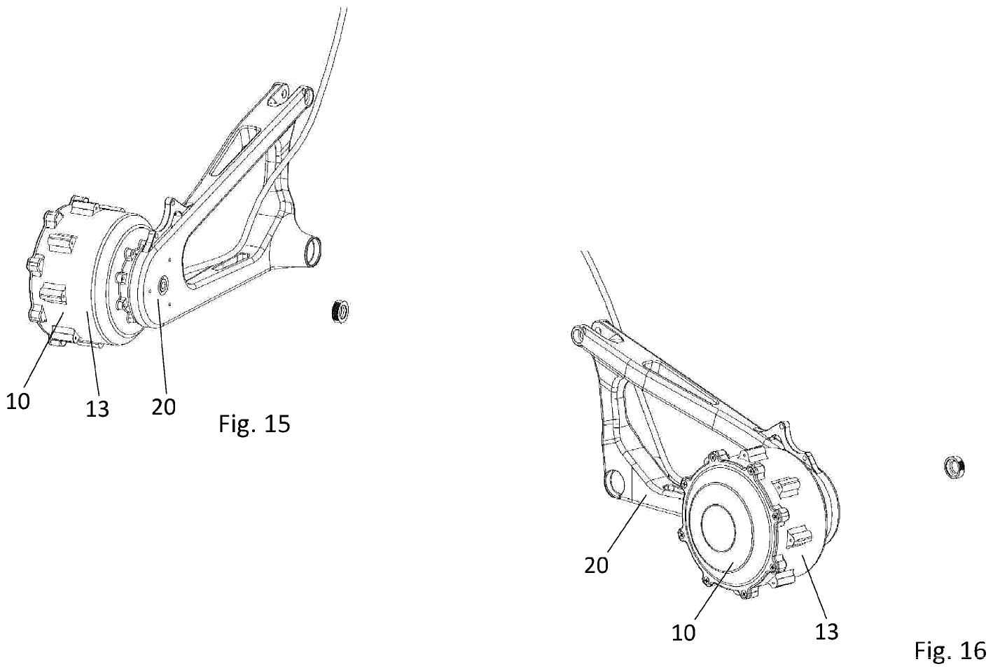

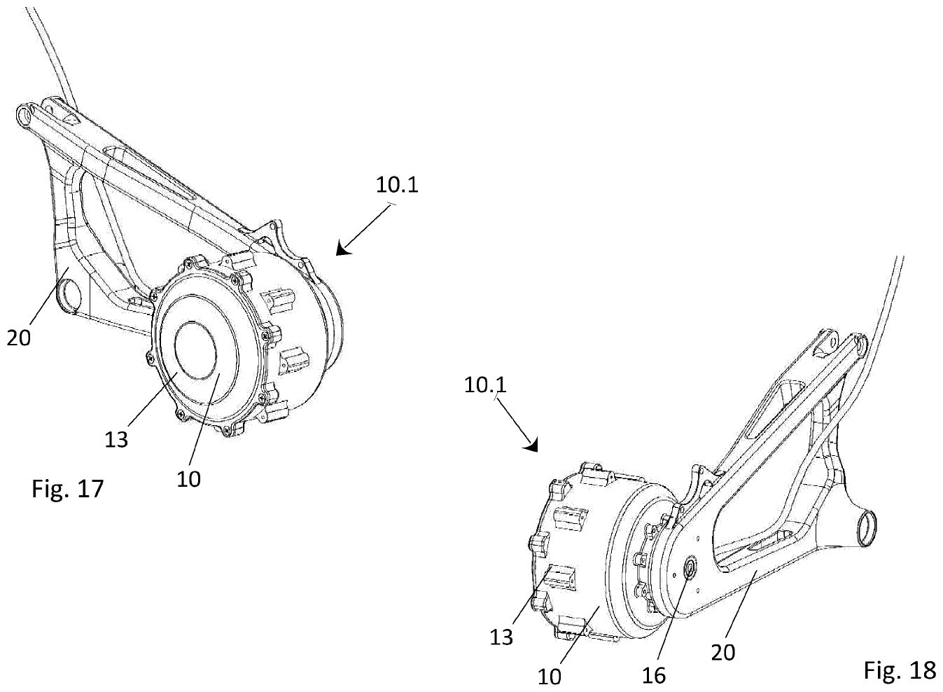

FIGS. 11 and 12 show an exploded view in which all parts are not yet attached to one another. The electrical device 10 is separated from the part 20 of the vehicle. The connector 11 and mating connector 21 are also not in contact with each other. In FIGS. 13 and 14, the electrical device 10 is plugged onto the part 20 of the vehicle. The electrical connection is likewise already established, since the plug connector 11 and the mating plug connector 21 are operatively connected to one another. Finally, a fastening screw is secured to the electrical device 10 by the part 20 of the vehicle, as shown in FIGS. 15 and 16. Finally, the screw is further secured with a nut, which can be seen from FIGS. 17 and 18.

As a result of this assembly process, it is clear that the assembly and disassembly of the electrical device 10 takes place with few manipulations by an operator and can be carried out without special training or tools. If such vehicles according to the invention are used over a large area, it is possible to quickly eliminate lengthy losses of service as occur in the event of failure of one of the electrical devices. The same electrical device can be mounted at different points on the vehicle and the mating plug connector can be provided both close to the axis of rotation of the electrical device and at a distance therefrom, so that the same electrical device can be used for many different vehicle types and applications in the same or also in different vehicles. This is favorable both in production and in storage. If a plurality of similar electrical devices are provided on a vehicle, an operator does not have to carry a replacement for each electrical device in order to be able to react in the event of a breakdown.

Finally, it should be pointed out that the embodiments illustrated here are merely exemplary implementations of the invention and are not limited thereto. Rather, modifications and modifications are also possible. The number of electrical devices and the locations of the assembly are virtually freely selectable. The vehicle can also have two, three or four wheels and can also be equipped with a trailer.

### LIST OF REFERENCE SYMBOLS

10 Electrical device
10.1 Assembly position of 10
11 Plug connector
12 Receptacle
13 Housing of 10
14 Transition piece
15 Guide
16 Axis of rotation of 10
20 Part of a vehicle
21 Mating plug connector
30 Adapter
31 Body of 30
32 Cover

1. An electrical connection between an electrical device (10) and at least one part (20) of an at least partially electrically operable vehicle, in particular of a vehicle with a serial hybrid drive,
wherein the electrical device (10) has an axis of rotation (16) and can be fastened to the part (20) of the vehicle in a mounting position (10.1),
wherein electrical energy and/or data can be transmitted from the vehicle to the electrical device (10) and/or from the electrical device (10) to the vehicle via the electrical connection,
wherein at least one plug connector (11) is provided on the electrical device (10) and at least one mating plug connector (21) for producing the electrical connection is provided on the vehicle or on the part (20) of the vehicle,
and wherein the electrical connection between the at least one plug connector (11) and the at least one mating plug connector (21) is automatically established when the electrical device (10) is transferred to its mounting position (10.1) on the vehicle,
characterized in that on the one hand the plug connector (11) is arranged directly on the axis of rotation (16) of the electrical device (10), wherein the mating plug connector (21) is likewise arranged on the vehicle in the region of the axis of rotation (16) of the electrical device (10),
and that on the other hand a transition piece (14) is provided, on which the plug connector (11) is arranged and which bridges a distance between the electrical device (10) and the mating plug connector (21) is thereby spaced apart from the the rotational axis (16) of the electrical device (10) when the mating plug connector (21) is arranged on the vehicle.

2. The electrical connection according to claim 1, characterized in that a guide (15) is provided, into which the transition piece can be introduced in order to make an electrical connection between the device (10) and the vehicle, easing a transfer the electrical device (10) into its mounting position (10.1).

3. The electrical connection according to claim 1, characterized in that the mounting position (10.1) of the device (10) is mechanically unambiguously defined and protected against assembly errors.

4. The electrical connection according to claim 1, in that the electrical device (10) is a motor or a generator.

5. The electrical connection according to claim 1, characterized in that the device (10) is arranged in a region of a wheel hub of a wheel of the vehicle.

6. The electrical connection according to claim 1, characterized in that the device (10) is arranged on the vehicle in a region of pedals which can be actuated by a person.

7. The electrical connection according to claim 1, characterized in that a receptacle (12) for the device (10) or for a part of the device (10) is provided, into which the device (10) can be introduced for transferring into its mounting position (10.1).

8. The electrical connection according to claim 7, characterized in that an adapter (30) is provided, which can be fastened to the vehicle or to a part (20) of the vehicle and has the receptacle (12).

9. The electrical connection according to claim 8, characterized in that the adapter (30) is designed in the manner of a capsule and comprises a body (31) and a releasably attachable cover (32).

10. The electrical connection according to claim 7, characterized in that the mating plug connector (21) is arranged on the receptacle (12), or on the adapter (30), or on the receptacle (12) and on the adapter (30).

11. The electrical connection according to claim 1, characterized in that the device (10) has a housing (13) having an outside and the plug-in connector (11) is arranged on the outside of the housing (13).

12. The electrical device (10) for use on or in an at least partially electrically operable vehicle suitable for bringing about an electrical connection according to claim 1, wherein the device (10) comprises at least one of a motor and a generator and a transmission and has at least one plug connector (11) accessible from outside and at least one transition piece (14) indirectly or directly.

13. An at least partially electrically operable vehicle, having a serial hybrid drive, having at least one electrical device (10) and having at least one electrical connection according to claim 1.
